(19) United States
(12) Patent Application Publication
(10) Pub. No.: US 2014/0215381 A1
(43) Pub. Date: Jul. 31, 2014

(54) METHOD FOR INTEGRATING AND DISPLAYING MULTIPLE DIFFERENT IMAGES SIMULTANEOUSLY IN A SINGLE MAIN-WINDOW ON THE SCREEN OF A DISPLAY

(71) Applicant: ACTI CORPORATION, Taipei City (TW)

(72) Inventors: YAN-HAO HUANG, TAIPEI CITY (TW); CHING-WEN LI, NEW TAIPEI CITY (TW)

(73) Assignee: ACTI CORPORATION, Taipei City (TW)

(21) Appl. No.: 14/153,584

(22) Filed: Jan. 13, 2014

(30) Foreign Application Priority Data
Jan. 29, 2013 (TW) 102103318

(51) Int. Cl. G06F 3/0484

(52) U.S. Cl. CPC G06F 3/04842
USPC 715/781

(57) ABSTRACT

A method for integrating and displaying multiple different images simultaneously in a single main-window on a screen of a display is executed in a system with a split screen layout displaying images in sub windows, comprising steps as follows: continuously select multiple focal windows on the split screen layout with a pointer tool; click an image join icon included in the system to activate an image join process; click an export icon included in the system to integrate images in the focal windows into a main-window for display. The method further comprises a step to set up attributes of images to be displayed in the focal windows. According to the steps, the multiple images on a split screen layout are clicked, chosen and integrated into a single main-window based on configured export conditions for a user's check and management.

### BACKGROUND

1. Technical Field

A method for integrating and displaying multiple different images simultaneously in a single main-window on the screen of a display, particularly a method for integrating and displaying multiple dynamic or static images in a single main-window which can he easily checked and managed.

2. Descriptions of the Related Art

As one image monitoring system extensively installed all over the modern society such as premises, apartment buildings, warehouses, companies and families, the image monitoring system is intended to synchronously and instantaneously monitor various corners in one environment, prevent crimes and provide evidences for any case.

As shown in FIG. 1, a current image monitoring system consists of several video cameras 1 set up in different corners, a monitor server 110 and a monitor screen 11.The video cameras 1 transmit image signals to the monitor server 10; the monitor server 10 processes various image signals simultaneously, decodes the signals, transmits the decoded signals to the monitor screen 11 for play, and saves images files into external hard discs.

To simultaneously display multiple real-time images captured by several video cameras on a single monitor screen 11 and observed by a user, the abovementioned monitor server 10 saves processed image signals in image files which will be further compressed to fit smaller sub-windows and complete image synthesis based on default configurations of a split screen layout.

The function of displaying multiple images on a single monitor screen provides a user an opportunity to track evidences via images and look for any key frame recording events such as crime or traffic accident at different corners simultaneously.

As mentioned above, the function of sub-windows to offer real-time images captured from different angles of view or play several image files later allows a user to track and observe such several image files simultaneously or monitor such real-time images from different corners on a finite-sized screen. However, a user who finds key frames recording events such as crime or traffic accident captured at specific corners either real-timely or during a backtracking course has to laboriously find out many image files saved in hard discs and manually retrieve relevant images as evidences but the criminal has escaped at the same time.

Accordingly, how to immediately and easily capture multiple dynamic or static key frames on a split screen layout, and integrate and display them in a single main-window has become one topic deserving to be studied by the person skilled in the art.

### SUMMARY

A method for integrating and displaying multiple different images in a single main-window on a screen of a display is executed in an image monitoring system, which comprises a split screen layout on a single display screen to present each image in a sub-window on the split screen layout. The system has an image join icon and an export icon, and the method comprises steps as follows:

Step 1: Continuously select multiple focal windows on the split screen layout with a pointer tool;

Step 2: Click the image join icon included in the system to activate an image join process; and

Step 3: Click the export icon included in the system to integrate images in the focal windows into a main-window for display.

The method further comprises a Step 4 between Step 1 and Step 3: Set up attributes of images to be displayed in the focal windows.

The main-window can be equipped with a save icon through which a user saves images displayed in the main-window and the system stores the images into a single image file.

According to the steps, the multiple images on a split screen layout can be clicked and further integrated into a single main-window based on configured export conditions for a user's check and management on the main-window.

In the above descriptions, the images can be real-time images or any saved image files.

### BRIEF DESCRIPTION OF THE DRAWINGS

FIG. 1 is a schematic view illustrating a conventional monitoring system.

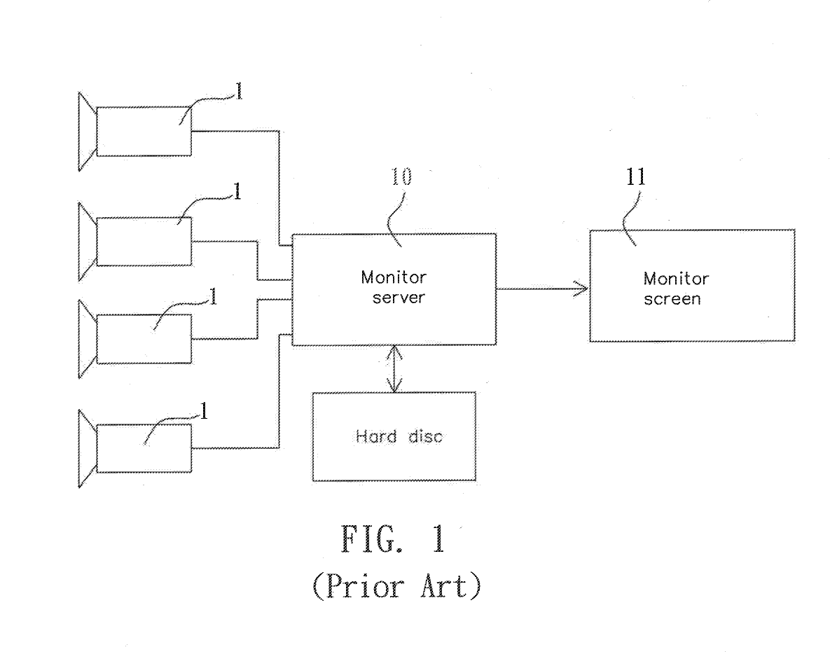

FIG. 2 is a flow diagram illustrating a method for integrating and displaying multiple different images in a single main-window on a screen of a display in an embodiment.

FIG. 3 is a flow diagram illustrating a method for integrating and displaying multiple different images in a single main-window on a screen of a display in an alternative embodiment.

FIG. 4 is a schematic view illustrating a process of using a method for integrating and displaying multiple different images in a single main-window on a screen of a display.

### DETAILED DESCRIPTION

The technical measures and effects are particularly presented in the preferred embodiments and accompanying drawings to realize the above purposes.

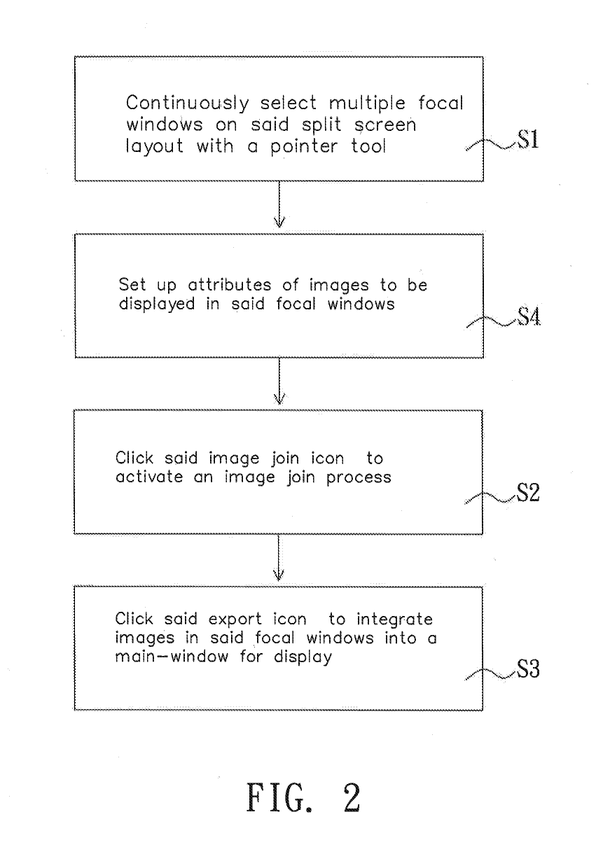

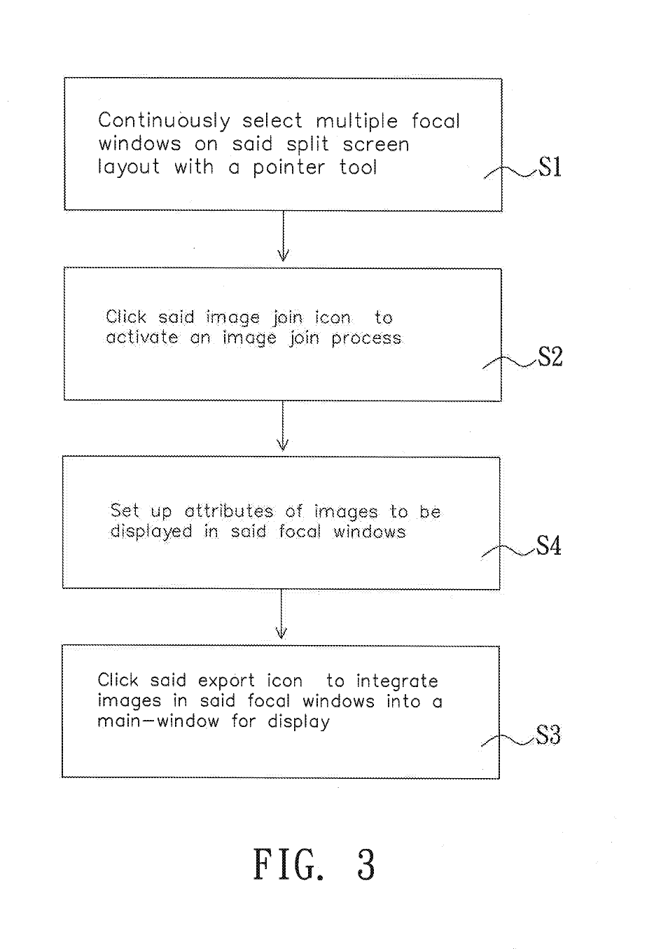

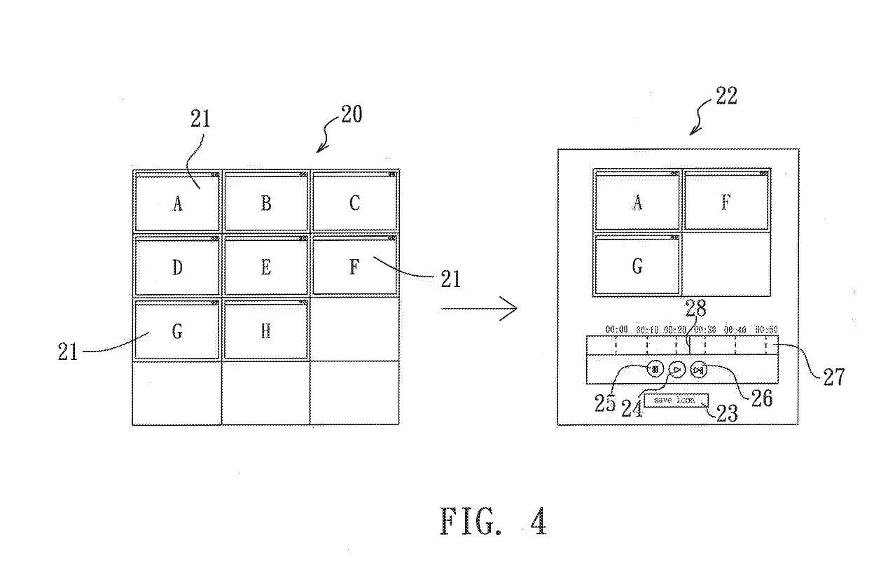

Refer to FIG. 2 through FIG. 4: FIG. 2 is a flow diagram illustrating a method for integrating and displaying multiple different images in a single main-window on a screen of a display in an embodiment; FIG. 3 is a flow diagram illustrating a method for integrating and displaying multiple different images in a single main-window on a screen of a display in an alternative embodiment; FIG. 4 is a schematic view illustrating a process of using a method for integrating and displaying multiple different images in a single main-window on a screen of a display.

As shown in FIG. 2 through FIG. 4, a method for integrating and displaying multiple different images in a single main-window on a screen of a display is executed in a system which comprises a split screen layout 20 displayed on a single display screen and is an image monitoring system that accesses multiple dynamic or static images (hereinafter referred to as images) saved in a monitor server 10 or devices externally connected to the monitor server 10. The dynamic or static images include, without limitation, real-time images such as live images played by the image monitoring system or saved images and are displayed in different sub-windows on the split screen layout 20. The system has an image join icon and an export icon, and the method comprises steps as follows:

Step 1: A user continuously selects multiple windows known as focal windows 21 on the split screen layout 20 with a pointer tool (S1);

Step 2: Click the image join icon to activate an image join process (S2); and

Step 3: Click the export icon to integrate images in the focal windows 21 into a main-window 22 for a user's check and management (S3).

The method further comprises Step 4 between Step 1 and Step 3: Set up attributes of images to be displayed in the focal windows 21 (S4). As shown in FIG. 2 for one embodiment, Step 4 between Step 1 and Step 2 is used to set up attributes of images to be displayed in the focal windows 21 before the image join process. As shown in FIG. 3 for another embodiment, Step 4 between Step 2 and Step 3 is used to set up attributes of images to be displayed in the focal windows 21 after the image join process.

In a further embodiment, the main-window 22 is equipped with a save icon 23 through which a user saves images displayed in the main-window 22 and the system stores the images into a single image file for the user's further management.

The pointer tool in Step 1 can be a mouse, a touch pen or a finger which depends on the type of the display screen, for example, a touch pen or a finger for a touch panel as the display screen.

The images displayed in the focal windows 21 in Step 4 can be static images or dynamic images.

A user can set up to capture the images with the same timing simultaneously in the focal windows 21 according to configurations for static images displayed in the focal windows 21, i.e., all static images in the focal windows 21 are captured synchronously. With the images in the different focal windows 21 configured to be captured at the same timing, the system will pop up a time picker window in which a user can enter at least the target time as a condition to capture images and export them from the focal windows 21.

Moreover, a user can set up to capture the images with partially or totally different timing separately in the focal windows 21 according to configurations for static images displayed in the focal windows 21, i.e., all static images in the focal windows 21 can be captured synchronously or asynchronously. With the images in the different focal windows 21 configured to be captured at partially or totally different timing, the system will pop up a time picker window separately in which a user can enter at least the target time as a specific condition to capture an image and export it from one of the focal windows 21.

On the other hand, a user can set up to capture the images with an identical time interval in the focal windows 21 according to configurations for dynamic images displayed in the focal windows 21, i.e., all dynamic images in the focal windows 21 are integrated and exported with an identical duration. To capture the dynamic images in the different focal windows 21 over the identical time interval, the system will pop up a time picker window in which a user can enter at least start time and end time as conditions to export images from the focal windows 21.

Furthermore, the focal windows 21 can be configured to partially display static images and dynamic images by referring to the above descriptions without limitation.

The main-window 22 in Step 3 is a split-window which comprises and integrates the focal windows 21 based on configured export conditions, and the main-window 22 further comprises at least one of other three icons, e.g., a play icon 24, a pause icon 25 and a stop icon 26, by which a user is able to check and control images in the main-window 22. Furthermore, the main-window 22 can be also equipped with a timer shaft 27 and an executive cursor 28: the executive cursor 28 indicates the timing at the timer shaft 27 for each image displayed in the main-window 22; the timer shaft 27 presents the timing indicated by the executive cursor 28 for convenient check and management.

The dynamic images can be real-time images or an image file to be played: the file format of the dynamic images can be MP4, MOV, AVI or a specific format exclusively for the system; the static images are saved as an ordinary image file with a file format including, without limitation, JPG, BMP, TIF or TGA, or a specific format exclusively for the system.

As mentioned above, a user is capable of selecting multiple images from a split screen layout conveniently, integrating and displaying them in a single main-window by configured export conditions, and easily completing check and management in the single main-window which simplified a process to analyze, compare and control multiple dynamic and static images.

Accordingly, a method for integrating and displaying multiple different images simultaneously in a single main-window on a screen of a display has been disclosed in above embodiments. The above descriptions are preferred embodiments which do not limit the scope of a method for integrating and displaying multiple different images simultaneously in a single main-window on a screen of a display; any equivalent change or improvement without departing from spirit of the present disclosure should be incorporated in claims herein.

What is claimed is:

1. A method for integrating and displaying multiple different images simultaneously in a single main-window on a screen of a display which is executed in a system with a split screen layout, an image join icon, an export icon and multiple sub-windows thereon for display of different images, comprising steps as follows:
Step 1: Continuously select multiple focal windows on said split screen layout with a pointer tool;
Step 2: Click said image join icon to activate an image join process; and
Step 3: Click said export icon to integrate images in said focal windows into a main-window for display.

2. A method for integrating and displaying multiple different images simultaneously in a single main-window on a screen of a display according to claim 1 further comprises Step 4 between Step 1 and Step 3: Set up attributes of images to be displayed in said focal windows.

3. A method for integrating and displaying multiple different images simultaneously in a single main-window on a screen of a display according to claim 2 wherein said system is an image monitoring system.

4. A method for integrating and displaying multiple different images simultaneously in a single main-window on a screen of a display according to claim 2 wherein said split screen layout is only displayed on a single display screen.

5. A method for integrating and displaying multiple different images simultaneously in a single main-window on a screen of a display according to claim 2 wherein said images are real-time images or saved image files.

6. A method for integrating and displaying multiple different images simultaneously in a single main-window on a screen of a display according to claim 2 wherein said images to be displayed in said focal windows in Step 4 are static images or dynamic images.

7. A method for integrating and displaying multiple different images simultaneously in a single main-window on a screen of a display according to claim 6 wherein said images to be displayed in said focal windows in Step 4 are static images and can be configured to be captured at the same timing.

8. A method for integrating and displaying multiple different images simultaneously in a single main-window on a screen of a display according to claim 7 wherein said system in Step 4 will pop up a time picker window in which a user can enter at least the target time as a condition to capture images and export them from said focal windows.

9. A method for integrating and displaying multiple different images simultaneously in a single main-window on a screen of a display according to claim 6 wherein said images to be displayed in said focal windows in Step 4 are static images and can be configured to be captured at partially or totally different timing.

10. A method for integrating and displaying multiple different images simultaneously in a single main-window on a screen of a display according to claim 9 wherein said system in Step 4 will pop up a time picker window separately in which a user can enter at least the target time as a specific condition to capture an image and export it from one of said focal windows.

11. A method for integrating and displaying multiple different images simultaneously in a single main-window on a screen of a display according to claim 6 wherein said images to be displayed in said focal windows in Step 4 are dynamic images and can be configured to be captured at an identical time interval.

12. A method for integrating and displaying multiple different images simultaneously in a single main-window on a screen of a display according to claim 11 wherein said system in Step 4 will pop up a time picker window in which a user can enter at least start time and end time as conditions to export images from said focal windows.

13. A method for integrating and displaying multiple different images simultaneously in a single main-window on a screen of a display according to claim 6 wherein said focal windows in Step 4 are able to partially display static images and dynamic images.

14. A method for integrating and displaying multiple different images simultaneously in a single main-window on a screen of a display according to claim 6 wherein the file format of said dynamic image is MP4, MOV or AVI.

15. A method for integrating and displaying multiple different images simultaneously in a single main-window on a screen of a display according to claim 6 wherein the file format of said static image is JPG, BMP, TIF or TGA.

16. A method for integrating and displaying multiple different images simultaneously in a single main-window on a screen of a display according to claim 2 wherein said main-window in Step 3 is equipped with a save icon through which said system stores said images displayed in said main-window into a static image file or a dynamic image file.

17. A method for integrating and displaying multiple different images simultaneously in a single main-window on a screen of a display according to claim 2 wherein said pointer tool is a mouse, a touch pen or a finger.

18. A method for integrating and displaying multiple different images simultaneously in a single main-window on a screen of a display according to claim 2 wherein said main-window further comprises at least one icon among a play icon, a pause icon and a stop icon.

19. A method for integrating and displaying multiple different images simultaneously in a single main-window on a screen of a display according to claim 2 wherein said main-window further comprises a timer shaft and an executive cursor which presents timing at said timer shaft for each image displayed in said main-window.
